(19) United States
(12) Patent Application Publication
(10) Pub. No.: US 2012/0330761 A1
(43) Pub. Date: Dec. 27, 2012

(54) Unconnected Advertising for Electronic Books

(75) Inventor: Jon Cameron, Dallas, TX (US)

(73) Assignee: DAVID DUNLAP, LLC, Dallas, TX (US)

(21) Appl. No.: 13/603,166

(22) Filed: Sep. 4, 2012

(51) Int. Cl. G06Q 30/02

(52) U.S. Cl. 705/14.73

(57) ABSTRACT

A system and method of making advertising accessible to eBook devices unconnected to online advertising delivery systems. The eBook is delivered to the reading device accompanied by advertising files to be delivered as the user is interacting with electronic book or eReader. This system allows institutions to conduct fundraising, helps publishers increase revenue, or decreases the cost of the eBook to the final user.

### BACKGROUND

1. Field of Invention

The invention related to the system and method of displaying real-time advertising with electronic books without the electronic reader hardware being connected to the internet.

2. Background of the Invention

The present invention is a useful and novel invention for adding advertising to electronic books on a device unconnected to the internet at the time the advertisement is delivered.

Electronic books, or eBooks, are nonpaper copies of documents distributed to consumers through electronic means. The eBook can subsequently be printed to paper or read directly on a device's output to a screen. eBooks are also variously referred to as e-books, e-editions, or digital books.

### Length and Content

Originally, the term eBook referred to book-length works of fiction and non-fiction. Cultural evolution has extended eBooks to include works of any length including reports, reviews, newspapers and periodicals.

eBooks may contain text, static images, animated graphics, internal links, external links, translations, imbedded sound, pop-ups and video content. However, the vast majority of eBooks distributed today are primarily restricted to text and static image content. This is because publishing houses are limited to basic content formats by specialized and proprietary hardware reader's capabilities that dominate the eReader market. See the Display Devices discussion below.

eTextbooks

Electronic education materials, or eTextbooks, are a newer entry into the eBook industry. eTextbooks include student texts, supplemental study material, testing aides, educator manuals, and reference libraries such as dictionaries. eTextbooks are typically content rich and use every type of visual content typically associated with internet web browsers.

eTextbooks were first published with a focus on higher education. The traditional higher education market was characterized by steeper price points and consumers with a high prevalence of devices capable of displaying eBooks. In little time, the possibilities of eTextbooks to enhance and individualize education became apparent to high school, middle school and elementary educational institutions. Political issues, uniform access to the internet, distribution agreements, and hardware costs have slowed the adoption by pre-collegiate education institutions. However, interest remains high as these institutions sort out the issues of digital textbooks.

### Display Devices

The display of eBooks can be accomplished on four distinct hardware devices.

1. Personal Computer. The personal computer, or PC, is the most senior type of device for displaying eBook material. In the 1970s, the Dynabook notebook computer was originally proposed for the purpose of displaying books instead of using a printed version. Today, the personal computer is still heavily used in the distribution and display of eBooks.
2. Mobile Phone. The convenience of the ubiquitous personal mobile phone have made them a popular distribution channel for publishers and distributors. Mobile phones are somewhat problematic for consumers because the underlying operating systems may not be able to provide conveniences associated with other eBook devices: full-page display; bright-light reader; font size adjustment; and, touch screen for both page turning and scrolling.
3. Tablet. Personal computers primarily operated by the user's touch are crudely differentiated in the consumer market as “tablets.” Tablets may actually present nearly identical functionality as mobile phones and PCs. Tablets are sometimes also distinguished from mobile phones and PCs by the devices' size. Too large to fit into a clothing pocket, tablets provide a more ideal electronic book screen size than mobile phones. Smaller and lighter than typical PC configurations, the tablets provides portability associated with paper books. However, the lines are blurring against both mobile phones and PCs. Mobile phone screens are growing in size with newer models described as “small tablets.” Comparatively, the introduction of improved processing chips, smaller battery footprints, and high-capacity solid-state storage, PCs are rivaling the weight and size of tablets.

Characteristics of tablets continue to blur as PC-like variations now include physical keyboards, integrated mouse pad, and screen covers. Tablet usage shows a high dependence on a continuous internet connection through either the Wi-Fi or cellular connection.

4. Dedicated eReader. Electronic book readers, variously referred to as eBook device, eReader or eBook reader, are the latest hardware forms for reading eBooks. The dedicated eReader is specifically designed to mimic the footprint of a hardbound novel. The eReaders almost exclusive use is for reading of books and periodicals. Modern hardware versions focus on characteristics that improve the reading experience: visibility in bright or direct light; and long battery life. eReaders are typically sold at a loss by digital eBook sellers allowing the sellers to be the exclusive provider of content. eReaders may be able to connect to the internet through various wired or wireless input devices. As eReaders become more connected, manufacturers and 3^{rd} party developers are offering applications typically associated with mobile phones and tablets. Dedicated eReaders have not had the broad market appeal anticipated by early pundits. Instead the limited hardware configuration has been largely ignored by the application-intensive younger consumer. eReader adoption is primarily among consumers age 55+. Ninety percent (90%) of eReader users only use the device for reading books or periodicals. Industry experts believe dedicated eReader hardware could be phased out by tablet adoption.
eBook File Format

eBooks cannot be distinguished by the file type. Today, the most popular way to distribute electronic books is by using the portable document format, or *.pdf, popular in all forms of document distribution. HTML is a popular format that is also used in website development. However, there are copious numbers of file types used for eBooks and there are many more to be advanced. Current file types include eReader (*.pdb), Plain text (*.txt), PostScript (*.ps), Multimedia EBook (*.exe), Repligo (*.rgo), Microsoft Word (*.doc*), ArchosReader (*.aeh), DjVu (*.djvu), FictionBook (*.fb2), Kindle (*.azw), TealDoc (*.pdb), EPUB (*.epub), Microsoft Reader (*.lit), and Mobipocket (*.prc, and *.mobi).

### Distribution and Loading Content

There are four distinct methods for loading electronic books into the display devices.

1. Preloaded. This is a common approach to load “free” eBooks to electronic readers prior to shipment. These are uncopyrighted or eBooks sponsored by the hardware provider.
2. Tethered. Many display devices for eBooks are limited to a USB connection to a personal computer for loading an eBook to the display device. This process is often an elaborate scheme that makes it difficult to train consumers. An example process for loading an eBook:
1. On PC, start eBook download application.
2. Within the PC application, click on the eBook store.
3. In the eBook store, start the eBook reader library.
4. Click “Import Files.”
5. Select content to be imported to the PC.
6. Checkout.
7. Return to eBook store and click “Start Import.”
8. After files have been loaded to the PC, attach the USB cord to both the PC and eReader.
9. On PC, click on Library.
10. Select new item to added to eReader.
11. Drag items to the eReader icon on the menu ribbon.
12. On the eReader, open the Reader and select a book from your library.

While the process is tedious, it is cost effective for consumers who only wish to use the eReader for reading eBook and can download several books at once.

Some libraries use a tethered solution in the form of a download station for loaned eReaders.

3. Cloud. Cloud delivery makes the book available as a service to the end-recipient. For instance, when the user launches the eReader device, the eReader software is executed on a remote server. The library is also contained on a remote server allowing a sharing of resources. The eReader simply acts as a dumb terminal by sending commands from the device to the cloud. Cloud delivery requires a continuous connection to the network. Cloud solutions are particularly useful for institutions like libraries. Cloud delivery of the eReader application is not considered under the present invention.
4. Internet Download. The most convenient form of loading content to the eReader is the use of a wired or wireless connection to connect the eReader to an online book catalog. The eBook file is electronically downloaded to the reading device once it has been purchased or rented. The electronic reader does not need to be continuously connected in order for the user to read the file. To compare to the Tethered solution above, these are sample instruction for loading content with an internet download.
1. Turn on electronic reader.
2. Click on Store.
3. Search for content, scan a barcode, or select a saved item.
4. Click on title to add to basket.
5. Click on basket and checkout.
6. Click on title on the bookshelf to read.

The process can be completed in under a minute.

### Pricing and Compensation

Today, there are five methods for acquiring permanent or temporary rights to an electronic book. Some of the methods are combined such as the use of offset compensation to produce free-to-own pricing.

1. Free-to-own. There are millions of eBooks and e-editions without copyright being distributed free of charge that can be permanently stored in an individual's library. Many of the eReaders include a preloaded library of such titles.

Including advertising in these free-to-own files would provide an acceptable consumer trade-off considering the zero cost. This free-to-own category is expected to grow over the next decade as hardware providers and retailers replace the entire cost of the content with advertising.

2. Free-to-rent. The simplest example of this temporary distribution of free electronic documents is the public library. The consumer goes to a physical location to download an electronic file that includes an expiration date in the digital rights management tool. Unless the consumer renews the title, the active key expires and the digital file will no longer be accessible on the renter's eReader.

eBook advertising controlled by a public library provides all new opportunities to fund collections and eReader hardware while providing revenue splits to publishers and authors. However, publishers have no obligation to sell electronic titles to libraries and many do not. The reasons are mostly financial—with some cultural issues to overcome by traditional publishers. There is a movement by library groups to push publishers on expanding their electronic content distribution policies to include libraries. By allowing libraries to advertise inside free-to-rent electronic editions, publishers will be able to enjoy the necessary revenues to expand library-accessible catalog.

3. Fee to Rent. Fee to rent is an emerging model that provides access to new and older titles for an annual fee. Limitations might include the number of eBooks downloaded each year or the number of eBooks rented at a time.

However, the appeal of the latest titles on a predictable budget is an attractive benefit combination to consumers. As we saw with video subscription services, fee-to-rent eBooks are expected to grow significantly as a distribution channel.

4. Purchased. The oldest of the pricing models, permanent purchasing of digital books and e-editions is the bulk of the electronic document market. The consumer pays a discounted price to a digit retailer/hardware provider. These purchases are controlled by digital rights management but there is no time limitation included. While digital right management has always attempted to prevent the distribution of unauthorized electronic copies, newer software versions are more closely matching the consumer's capabilities if they were using a printed copy of the same material. For instance, a consumer is able to copy from a portable document format, or *.pdf, and then paste that text or image into other electronic files. In purchased eBooks, there is tightening in the digital rights management to prevent the electronic copying of text which matches the rights they have in printed books. Under fair use rules, a consumer could still manually copy the text for both printed books and electronic books.
5. Offset and Sponsored. Offset and fully-sponsored content refers to electronic books distributed at a reduced or eliminated cost and allows the consumer to keep the content permanently. To accomplish this, 3^{rd} parties provide funding to the publisher or retailer to a) reduce or eliminate costs to the purchaser, or b) increase the margin or revenue available to the publisher/retailer.

The sponsorship does not have to take the form of eBook advertising. For instance, eTextbooks could be partially or fully sponsored by a school district using public funds.

Offset and Sponsor can also be used for fundraising for an institution. School districts could use school sponsors to provide funding for educational materials and other programs requiring funding. For example, the sponsor would place an advertisement inside an eTextbook. A portion of the funds would be allocated to offsetting the cost associated with providing the eTextbook and a portion would be used for school functions such as booster club, field trips or sports programs.

Advertising in eBooks

Advertising in books has long been an intermittent practice by publishers. The practice thrived from the early 1900s through the 1960s. The '60s brought in more timely and effective advertising tools through television and full-color periodicals. Although outside advertising subsided in subsequent years, publishers still advertise their own products in the front and back of trade paperbacks today. These can be full color or black and white. They may include advertisement for other author's materials or advertisements for the author of the paperback.

The advent of eBooks has re-ignited publisher interest in advertising in books if for no other reason than to supplement their diminished margin on eBook formats. eReaders and tablets allow the delivery of timely advertising based on the human reader's profile, location of the eReader, browsing history, purchase history, book content, and other geodemographic material. Delivery can be measured in standardized return-on-investment set of calculations across dozens of data metrics. Essentially, the electronic format eliminates the issues that previously made books unattractive to advertisers.

However, publishers and authors have resisted much of the opportunity eBook advertising represents. Some of this has to do with the culture, and even the antiquated title, of “publishers.” Delivering content electronically eschews the business models, equipment and skill sets long associated with the publishing business.

Similarly, authors have been resistant to the changes eBooks represent to their income. eBooks sell for less than printed books because of consumer impression of reduced printing costs and eliminated middlemen. eBooks are causing large retailers to scale back on the title assortment in all publishing forms. The result is fewer titles are being picked up, advances have decreased dramatically and incomes for authors have similarly declined. eBooks return about half of the author's income compared to paper books.

Authors' views of eBook advertising have a direct correlation to their individual success and income. Established authors have resisted any advertising not directly related to their works. The perceived lack of controls over advertising content gives way to concern over the quality of the reading experience. Since authors directly control a book's content, inserting ads in eBooks won't happen without author approval. New or low-income authors have more readily adopted advertising as way to supplement their, and the publisher's, income. There are regular seminars on how authors can use advertising to boost income.

The end-users have expressed mixed, but certainly not enthusiastic, response to electronic book advertising. Academics see it as advertisers attempt to co-opting knowledge and culture channels. Consumers find the advertising obtrusive to the reading experience but hesitantly find value in the trade-off between less expensive hardware and eBooks. Online retailers with proprietary electronic readers have offered the eReaders at a lower retail if consumers agreed to allow advertising during power-up, after powering down and while shopping for titles. Perceived as unobtrusive, the ad-supported hardware has become very popular. Notably, this advertising is tied to a specific eBook, but to the hardware. However, the advertising allows the online retailer to take losses on the unit sales. Online retailers are expected to push for market share by moving retail prices of eBook as close to $0.00 as possible in the coming years. There is little doubt the consumer will find the value exchange worthwhile. It would also signal a steep demise to printed books as this “paper penalty” would diminish perceived value of printed books to nearly zero.

As the various electronic formats begin to merge and lose distinction, the lines will blur on what types of eBooks consumers find acceptable formats for advertising (such as e-periodicals) and unacceptable (a novel). eBooks will be begin looking like periodicals and nonfiction e-periodicals will begin looking more like electronic textbooks.

However, existing and emerging eBook advertising systems require the eBook have an internet connection or that the advertising be permanently embedded in the eBook content. The latter solution is reminiscent of book advertising of the early and mid-1900s. Once printed, always displayed. With today's rapid product evolution by marketers, this format has even less appeal in the present day.

Yet, the sense of portability eReaders provide consumers defy the notion they could be continuously connected while reading. For instance, many underage students do not have access to the internet at school and controlled access while at home. Adults reading on a commercial flight are without the necessary connection for ad delivery. Consumers may also learn to disable their internet connection as a tool to block advertising.

### Description of First Key Element of Prior Art

Connected eReader advertising. Real-time advertising delivery is based on the ability to transmit information to the server so an advertisement can be associated with data the electronic reader is able to collect and report. For instance, the eReader identifies specific content being viewed and displays related advertising materials adjacent to the content. Without a connection, the eReader collects information for the available advertising spot, unsuccessfully attempts to transmit, and leaves the advertising spot empty.

### Description of Second Key Element of Prior Art

Static eReader advertising. To provide advertising to electronic readers with infrequent connection, publishers rely on the same methods they use with trade paperback. They place their own product's advertising in the front and back of trade paperbacks which remains in place for the life of the book. This type of advertising has little appeal to outside advertisers because there is no ability to measure effectiveness of the advertisement delivery. Therefore, authors, publishers, and hardware providers are unable to generate revenue from third-party advertisers.

### Description of Third Key Element of Prior Art

Author and publisher resistance. For the copyright holders, the benefits of advertising in eBooks are not well balanced against the potential negative perception of the eBook's brand. Book advertising has long-suffered as a suboptimal solution to an undistinguishable problem. eReader advertising that is largely unassociated with the content of the eBook allows copyright owners to distance themselves from the advertising while controlling the location of the output. For instance, a writer can specify the eBook advertising would only appear after the eBook is opened and then only on the opening screen when the eReader is re-started.

### SUMMARY OF THE INVENTION

An invention, which meets the needs stated above, is a system and method that allows real-time display of advertising to electronic content even if the hardware does not have any connectivity at the time the advertisement is delivered.

### Objects and Advantages

Accordingly, besides the objects and advantages described of unconnected advertising in eBooks, further objects and advantages of the present invention are:
a) to provide a single connection that can download electronic books and advertising simultaneously;
b) to provide a method to update advertising files infrequently to display continuously;
c) to provide new funding opportunities for schools to pay for hardware, software, and content;
d) to provide new margins to publishers so they can expand the content they permit in libraries;
e) to provide new revenue for authors to encourage expansion of ebook catalogs;
f) to provide hardware suppliers with revenue sufficient to reduce the selling price of the content;
g) to provide hardware suppliers with revenue to eliminate the retailer price of the content;
h) to provide the ability to know the average advertising revenue generated for a title before the electronic book is downloaded;
i) to allow variable pricing of electronic books by determining available advertising at the time of download;
j) to prevent consumers from blocking advertising by disconnecting while reading;
k) to provide continuous scheduled advertising based on the expiration date of the active key in the rights management tool;
l) to provide funding for libraries to support their eBook collections and split revenues with distributors and publishers; and
m) to provide real-time advertising across the subset of the consumer's library downloaded at the same time.

Further objects and advantages of this invention will become apparent from a consideration of the drawings and the ensuing description of the drawings.

### DRAWING FIGURES

The accompanying drawings, which are incorporated in and constitute a part of this specification, illustrate embodiments of the present invention and together with the description, serve to explain the principles of this invention. In the figures;

FIG. 1.—Timeline depicting an example of how the content is delivered to the eReader and then subsequently displayed for the consumer.

FIG. 2A.—Flow chart depicting the flow of data from the sellers catalog to the consumer's library.

FIG. 2B.—Flow chart depicting the display of advertising and eBooks without a network connection.

### REFERENCE NUMERALS IN DRAWINGS

10 eBook, electronic book, electronic document, e-editions, digital books, title, eTextbook
20 eReader, eBook reader, eBook device, device, e-reader
30 Catalog, book catalog, eBook Catalog, retailer's inventory
35 Selection/Order, Select, Order
40 Library, book library, consumer's inventory
50 Advertisement, ad, advertising content
60 Advertising file
70 Advertising inventory database, advertising inventory, ad inventory
80 Advertising filter, ad filter
90 Server computer
100 Network

### DETAILED DESCRIPTION OF THE DRAWINGS

Referring to the drawings, in which like numerals represent like elements,

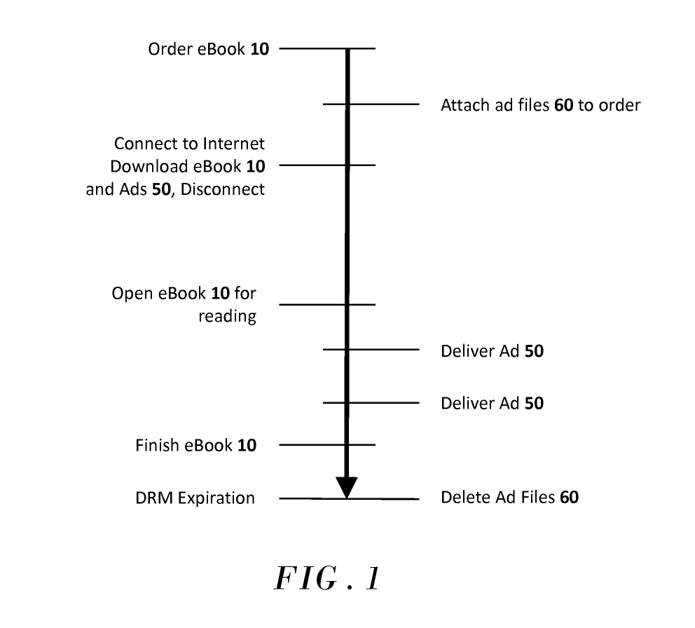

### FIG. 1

Turning to FIG. 1, the timeline shows and compares the delivery of content for an eBook 10 and an advertisement 50. Working top to bottom, the first step in the timeline is to place an order 35 for the electronic book 10. The order 35 can be made by the consumer browsing a catalog 30 and selecting a single, or a group of, titles 10. The titles 10 can continue to be accumulated at the catalog's 30 website until they are eventually downloaded to the eReader 20.

The catalog can be maintained by different entities within the electronic book 10 supply chain. Consumers typically think of an eBook 10 retailer as the seller. However, the seller can be an eReader 20 hardware manufacturer that is the exclusive provider of content to their hardware. It can also be a distributor responsible for supplying the functionality for the sale of publisher's titles 10. An example of a distributor catalog 30 would be a school district with an authorized catalog 30 for exclusive use within their school district. The eBook 10 market also has direct-to-publisher examples where specific publishers, such as educational institutions, publish their own eBooks 10 or e-editions 10. Somewhat rarer is when the author, or copyright owner, of the digital book 10 distributes their own material through a catalog 30 the author maintains. An example of this is electronic encyclopedia when the copyright owner runs an online catalog 30.

The order 35 can also be made by a third party such as a teacher or instructor. For instance, the teacher for an elementary school class can preselect a group of required and supplemental materials and store the selection 35 as subsets of the catalog 30. The order 35 process may not necessarily require a connection to the network 100 or server computers 90. For instance, a school district may submit a paper invoice or a teacher can call a representative of the catalog's 30 owner.

After a person or institution places the order 35 for the eBooks 10, the process then waits for a signal from the designated eReader 20 to begin the download of the content from the seller's catalog to the eReader's 20 library 40.

Once the download requested is made by the eBook device 20, the server computers 90 generate a signal to the advertising inventory database 70 to attach, or associate, advertising files 60 to the eBooks 10. This can be done by using an ad filter 80 which sorts the advertising 50 based on a large possibility of parameters. These parameters include the ordering-parties profile, the profile of the human reader, content associated with the pages of the eBook 10, profile of typical users of the eReader hardware 20, geodemographics of the purchasers of the specific title 10, advertising content 50 authorized by ordering party, and seasonal timing.

Notably, the only network 100 connection to the eReader 20 is required as the eBooks 10 and attached advertising files 60 are distributed to the eReader 20 after the eReader 20 connects to the network 100. Once the eBooks 10 and ad files 60 are downloaded to the eReader's 20 library 40, the eReader 20 can disconnect from the network 100. The present invention is based on a scenario when there is intermittent or rare connection to the internet. For instance, school children may have no internet connection while working on their eTextbooks 10 at their school. Additionally, they may have restricted access to the internet at home through parental controls. It would not be unusual for a student's eReader 20 to only connect to the servers 90 between semesters or when textbook updates are required.

At a later time, the human reader can access the eBook 10 on the eReader 20 and receive real-time advertising 80 without a connection to the network 100. Once the eBook 10 is accessed, the advertisements 50 can be delivered at various times until the human reader has finished the eBook 10.

Time delivery of the advertisement can be based on any number of factors, such as:
a) A particular date range;
b) A particular page, paragraph, or sentenced accessed;
c) Key words available on the viewing page;
d) The availability of the matching ad 50 size;
e) Seasonal timing;
f) Opening of the eBook 10;
g) Between chapters of the eBook 10;
h) Closing of the eBook 10;
i) Finishing of the eBook 10;
j) Deletion or archiving of the eBook 10.

It is also possible to include advertisements 50 with hyperlinks to external advertising 50 content despite the anticipated lack of network 100 connections. The eReader 20 can store the links associated with the hyperlinked advertisement 50 and then display the online content once the internet connection is later established.

In the last leg of the timeline, the digital rights management (DRM) software may determine that any temporary ownership of the eBook 10 has expired. At this time the title 10 would become inaccessible or be deleted with the advertising files 60.

As used herein, “eBook” 20 may include any file, in any file format, which is displayed on a hardware device with software designed for eBook reading. This can include electronic documents, electronic books, e-editions, digital books, electronic textbooks, electronic reference books, and electronic periodicals.

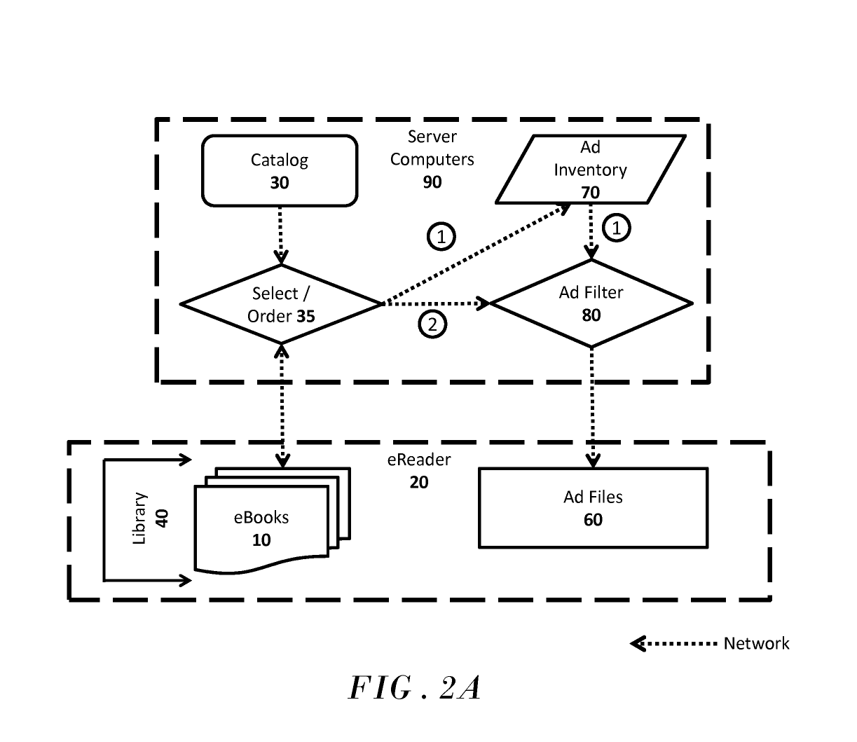

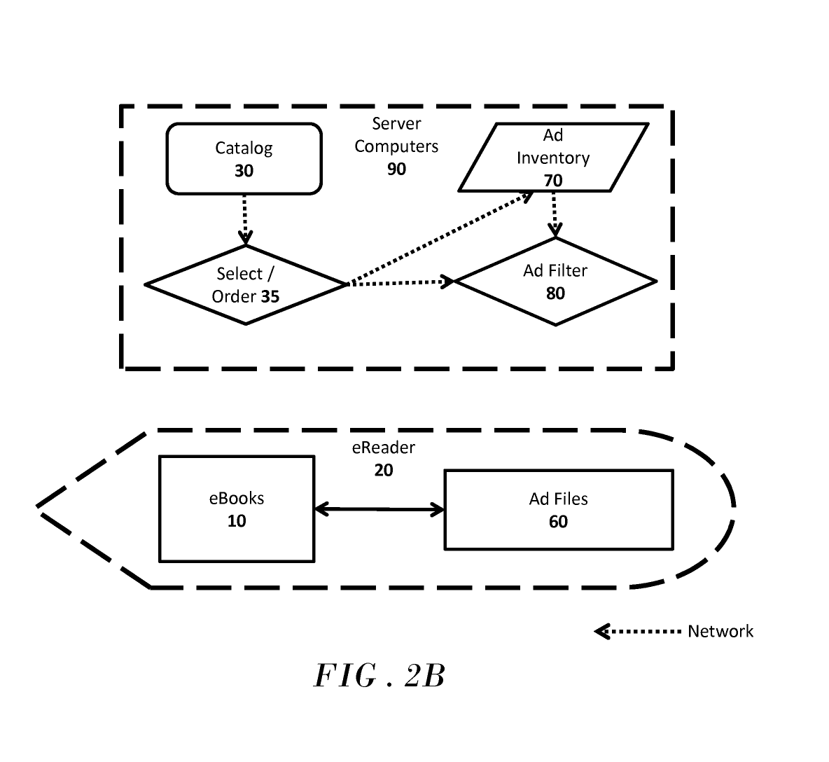

### FIGS. 2A-2B

Finally referring now to the combined FIGS. 2A and 2B, the logic flow charts depict the logistics of electronic distribution of eBooks 10 and advertisements 50 over the network 100 using server computers 90 and an eReader 20. FIG. 2B goes on to show the display of the eBook 10 and the advertising 50 on the eReader 20 while the eReader 20 is disconnected from the network 100.

The process begins with a catalog 30 of electronic books 10 stored on server computers 90 located on a network 100, the network 100 designated by dotted arrows in the figures. The catalog 30 can be maintained by the author, publisher, distributor, retailer, or the eReader's 20 hardware manufacturer.

Through a number of possible processes, a selection 35 of one or more eBooks 10 is made from the catalog 30. The selection 35 can be made without the use of an internet connection. For instance, a call center can take orders 35 over the phone and enter the order 35 into their internal server computers 90. Likewise, an order 35 can be placed by faxing a list of titles 10 to the seller. From these examples, it is clear a network connection is not required between the eReader 20 and the server computers 90 to be able to place the order 35.

As such, the selection and ordering 35 of the eBooks 10 may not initiate the download to the eReader 20. As a result of, it is the subsequent download request of the eBook device 20 that triggers the filtering of the advertising inventory 70 to create the advertising files 60 that will be associated with the eBooks 10. This can be done in one of two ways, designated by the circled numbers on the FIG. 2A.

The first method, designated by the circled “1,” is initiated when the order 35 download request sends a notice to the advertising inventory 70 storage server 90. The push notice from the order may contain a profile of the human reader, the eBook 10, eReader 20, ad 50 space available, the purchaser and any associated institutions. Using the profile information, the ad inventory's 70 ad filter 80 selects a group of advertising files 60 to associate with the eBooks 10.

The second method, designated by the circled “2” is initiated when the order 35 download request sends a notice directly to the ad filter 80. The ad filter 80 then takes the profile information from the order and runs a query against the ad inventory 70 on the server computers 90. Using the profile information, the ad inventory's 70 ad filter 80 selects a group of advertising files 60 to associate with the eBooks 10.

Series of eBooks 10, such as periodicals, or e-editions 10, could therefore be ordered 35 annually, for example, and then delivered monthly for the next twelve (12) months. This is important because the periodical's content for a December delivery would not be known if a subscription was ordered 35 in January of the same year.

Once the eReader 20 makes the download request, the coupled eBook 10 and advertisements 50 are distributed to the designated eReader 20.

FIG. 2B shows the eReader 20 as now disconnected to the server computers 90 and displaying both the eBooks 10 and advertising files 60. The two items do not have to be displayed simultaneously. For instance, the advertisement 50 may:
a) Show only once the eBook 10 is downloaded,
b) Only shown when the eReader 20 is initiated,
c) Only shown when the eReader 20 is turned off,
d) Be placed on the bookshelf of the library 40,
e) Be seen briefly when a eBook 10 is opened,
f) Be displayed between chapters or articles within the eBook 10,
g) Be seen when the eBook 10 is closed,
h) Lead to offline content stored with the ad file that is viewed within a browser,
i) Lead to online content that is viewed the next time the reader connects to the internet.

An embodiment of the present invention would include intermittent internet connections to the server computers 90 so that ad 50 updates could be made to the eReader 20 and then again disconnect to display the advertisements 50 and Books 10 offline to the human reader.

Benefits, other advantages, and solutions to problems have been described herein with regard to specific embodiments. However, the advantages, associated benefits, specific solutions to problems, and any element(s) that may cause any benefit, advantage, or solution to occur or become more pronounced are not to be construed as critical, required, or essential features or elements of any or all the claims of the invention. As used herein, the terms “comprises”, “comprising”, or any other variation thereof, are intended to cover a non-exclusive inclusion, such that a process, method, article, or apparatus composed of a list of elements, that may include other elements not expressly listed or inherent to such process, method, article, or apparatus.

### Advantages

From the description above, a number of advantages become evident for the “Unconnected Advertising for Electronic Books.” The present invention provides all new benefits for participating parties including authors, publishers, distributors, hardware providers and consumer, such as:
a) Allows consumers to have access to the full ad functionality even if they do not have connectivity;
b) Allows institution to offset eTextbook costs for students without consistent internet connectivity;
c) Allows publishers to prevent ad blocking by the consumer turning off the internet connection;
d) Allows authors to deliver advertising without a direct association with the eBook;
e) Allows publishers to expand the number of titles available for eBooks;
f) Allows hardware providers to offset hardware and eBook costs;
g) Allows a library to grow eBook available titles by splitting advertising revenue with publishers;
h) Allows advertisers to provide continuous advertising without an internet connection;
i) Allow distributors, such as school districts, to raise funding through endorsements.

What is claimed is:

1. A system comprising:
a. An at least one server computers coupled to a network;
b. An at least one catalog databases comprising one or more electronic books coupled to the at least one server computers;
c. An at least one inventory databases comprising one or more advertising files coupled to the at least one server computers;
d. One or more advertising filters coupled to the at least one server computers;
wherein the at least one server computers are for:
receiving an order for obtaining one or more electronic books for distribution from the at least one catalog databases;
a connection to a designated electronic reader signaling the advertising filters to select one or more advertising files from the advertising inventory databases;
based on a request from the electronic reader, distributing the one or more electronic books and the one or more advertising files;
displaying the electronic books and the advertisements without the network connection.

2. The system of claim 1, wherein the at least one catalog databases is controlled by the publisher.

3. The system of claim 1, wherein the at least one catalog databases is controlled by the distributor.

4. The system of claim 1, wherein the at least one catalog databases is controlled by the retailer.

5. The system of claim 1, wherein the at least one catalog databases is controlled by the hardware manufacturer.

6. The system of claim 1, wherein the at least one catalog databases is controlled by the author.

7. The system of claim 1, wherein one or more advertising files contain executable instructions.

8. The system of claim 1, wherein the one or more advertising files contain hyperlinks for displaying additional content after the electronic book connects to the network.

9. A system comprising:
a. An at least one server computers coupled to a network;
b. An at least one catalog databases comprising one or more electronic books coupled to the at least one server computers;
c. An at least one inventory databases comprising one or more advertising files coupled to the at least one server computers;
d. One or more advertising filters coupled to the at least one server computers;
wherein the at least one server computers are for:
receiving an order for obtaining one or more electronic books for distribution from the at least one catalog databases;
a connection to a designated electronic reader signaling the advertising inventory database to select one or more advertising files using the advertising filter;
based on a request from a electronic reader, distributing the one or more electronic books and the one or more advertising files;
displaying the electronic books and the advertisements without the network connection.

10. The system of claim 9, wherein the at least one catalog databases is controlled by the publisher.

11. The system of claim 9, wherein the at least one catalog databases is controlled by the distributor.

12. The system of claim 9, wherein the at least one catalog databases is controlled by the retailer.

13. The system of claim 9, wherein the at least one catalog databases is controlled by the hardware manufacturer.

14. The system of claim 9, wherein the at least one catalog databases is controlled by the hardware author.

15. The system of claim 9, wherein one or more advertising files contain executable instructions.

16. The system of claim 9, wherein the one or more advertising files contain hyperlinks for displaying additional content after the electronic book connects to the network.

17. A method for distributing electronic book advertising in a computer network environment comprising: selecting one or more electronic books for distribution to an electronic reader; selecting one or more advertisements to be distributed with the electronic books; establishing a connection with the electronic reader; transferring the one or more electronic books to the electronic reader; transferring the one or more advertisements to the electronic reader; displaying the electronic books and the advertisements while the electronic reader is unconnected to the network.

18. A method of claim 17, wherein the selecting of one or more advertisements contain executable instructions.
